(19) United States
(12) Patent Application Publication
(10) Pub. No.: US 2021/0279720 A1
(43) Pub. Date: Sep. 9, 2021

(54) ANOMALY DETECTION IN A RECURRING TRANSACTION SET

(71) Applicant: Wells Fargo Bank, N.A., San Francisco, CA (US)

(72) Inventor: Joon Maeng, Newcastle, WA (US)

(21) Appl. No.: 15/394,615

(22) Filed: Dec. 29, 2016

Related U.S. Application Data
(60) Provisional application No. 62/273,075, filed on Dec. 30, 2015.

(51) Int. Cl. G06Q 20/36; G06Q 20/40; G06Q 20/32

(52) U.S. Cl. CPC G06Q 20/36; G06Q 20/3224; G06Q 20/405

(57) ABSTRACT

A method may include receiving, at a computing device, a plurality of past transactions associated with a user account of a user; extracting transaction characteristics of a transaction of the plurality of transactions, the transaction characteristics including a location characteristic and a time characteristic; retrieving, based on the transaction characteristics, characteristics of the computing device at a time according to the time characteristic; comparing the transaction characteristics with the retrieved computing device characteristics based on a set of rules to determine a likelihood that the transaction is anomalous; and based on the likelihood indicating that the transaction is anomalous, presenting a notification to the user.

### CROSS-REFERENCE TO RELATED APPLICATION

This patent application claims the benefit of U.S. Provisional Patent Application No. 62/273,075, filed Dec. 30, 2015, entitled “Anomaly Detection in a Recurring Transaction Set”, which is incorporated by reference herein in its entirety.

### TECHNICAL FIELD

Embodiments described herein generally relate to data parsing and in particular, but without limitation, to anomaly detection in a recurring transaction set.

### BACKGROUND

Mobile wallets may be used for a variety of tasks including payments at a point-of-sale terminal, payments during an online web session, and payments using an application on a mobile device. A mobile wallet may additionally be used to pay existing bills through a bill pay service. A mobile wallet may store one or more wallet elements (e.g., credit cards, bank account identification) for payments.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram of mobile wallet, mobile wallet provider, and biller according to various examples;

FIG. 2 is a block diagram of a bill pay subsystem, according to various examples;

FIG. 3 is a table of bills, according to various examples;

FIG. 4 is a block diagram of an anomaly subsystem, according to various examples;

FIGS. 5 and 6 are flowcharts of methods to detect anomalies, according to various examples; and

FIG. 7 is a block diagram illustrating an example machine upon which any one or more of the techniques (e.g., methodologies) discussed herein may be performed, according to an example embodiment.

### DETAILED DESCRIPTION

Many organizations and devices have introduced electronic bill payment services. For example, a user may go to a web site and use the bill payment service or install a program in mobile device to make electronic bill payments. There are many technical limitations present in existing bill payment services that may lead to payments being made to bills that should have been flagged as anomalous. In one scenario, if a user sets up automatic payments, the payment service may pay erroneous bills without checking them, which may result in financial loss to the users.

In various examples described herein, a centralized system is used for automatic bill payment service for recurring bills. The payment service may provide an intelligent, automated, review function to avoid users having to manually review items in recurring bills and to prevent overpaying caused by erroneous automatic billing.

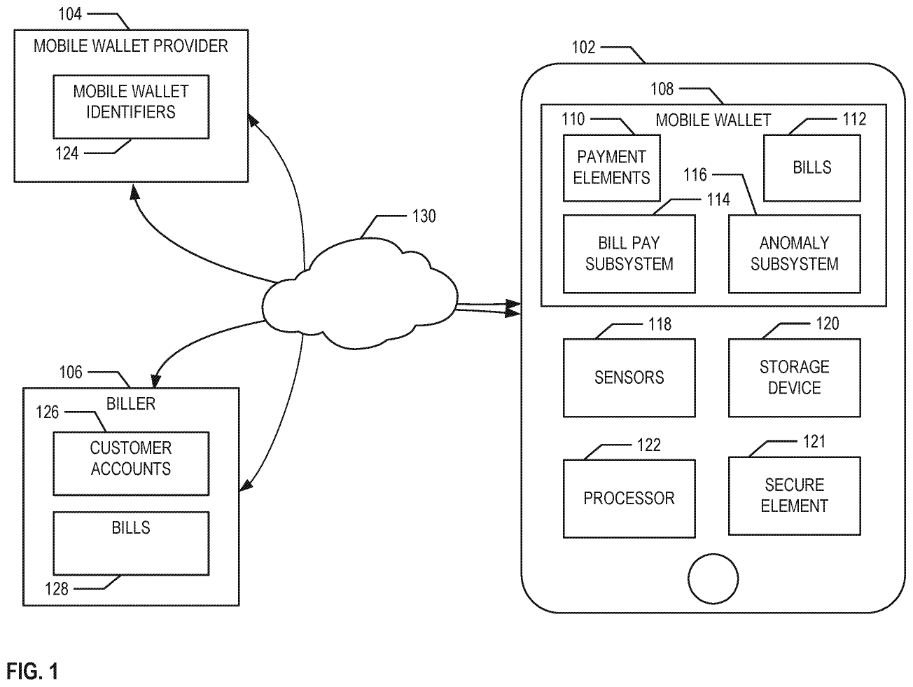

FIG. 1 is a schematic diagram of a mobile wallet 108, mobile wallet provider 104, and biller 106, according to various examples. The mobile wallet 108, mobile wallet provider 104, and biller 106 may communicate via network 130. The network 130 may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 130 may include a single local area network (LAN) or wide-area network (WAN), or combinations of LAN's or WAN's, such as the Internet

The mobile wallet 108 may be a digital wallet accessed through mobile device 102, such as a smartphone or tablet. However, the use of the mobile wallet 108 is not limited to such locations and the functionality of mobile wallet 108 may reside in devices external to the mobile device 102 such as a website or desktop applications. Accordingly, while the term “mobile wallet” is used in this disclosure, anomaly detection and other functionality described herein may be performed on non-mobile devices.

The mobile wallet 108 may be an executable application (e.g., via storage device 120) or web-based program that provides financial and non-financial services. Exemplary financial services include paying bills with credit card, debit card, or bank account and getting discounts with coupons. Examples of non-financial services include presenting an identification such as student card, insurance card, or driver's license. A mobile wallet provider 120 may be an entity that issued the mobile wallet 108 and provides the above services.

To facilitate the financial and non-financial use cases, mobile wallet elements may be stored. The mobile wallet elements may include credit card numbers, bank account numbers, user identifications, driver licenses, health cards, etc. Mobile wallet elements that are used for financial services may be stored as payment elements 110. The mobile wallet elements may be stored in storage device 120 or in secure element 121. The secure element 121 may be a storage location on the mobile device 102 that is separate from general user applications, which may be stored in storage device 120.

A user may add one or more mobile wallet elements via an interface of mobile wallet 108. For example, a user may use a camera sensor of sensors 118 to take a picture of a credit card. The mobile wallet 108 may perform optical character recognition to obtain the credit card number and card holder's name. The mobile device 102 may transmit a request to an issuer of the credit card to determine if the credit card number is valid and matches the card holder's name. A user may also add mobile wallet elements via a website or other interface served from mobile wallet provider 104. The mobile wallet provider 104 may in turn transmit data identifying the added mobile wallet elements to mobile device 102 to update mobile wallet 108.

A subset of the financial services provided by mobile wallet 108 may be payment of recurring bills. To set up a biller in bill pay, a user may visit a webpage of a biller and provide details on the mobile wallet 108 of the user. The details may include the type of mobile wallet provider that issued mobile wallet 108. For example, some mobile wallet providers may be the same entity that manufactured the mobile device 102; whereas others may be third-party application providers. The biller may use the type information to determine a location to transmit a bill for the user (e.g., a web server of mobile wallet provider 104). In some instances, the details may include an identifier of the user. Furthermore, in some examples, the biller 106 may transmit the bills directly to mobile device 102 without going through mobile wallet provider 104.

The mobile wallet provider 104 may include mobile wallet identifications 124 that identify (e.g., a mobile identification number) the mobile wallets issued by the mobile wallet provider 104. Accordingly, a bill may be transmitted from biller 106 to mobile wallet provider 104 and include a user identifier. The mobile wallet provider 104 may query mobile wallet identifications 124 with the user identifier to determine which mobile wallet the user identifier is associated with. Based on the results, the bill may be forwarded to mobile wallet 108. In some instances, mobile wallet 108 periodically requests new bills from mobile wallet provider 104 instead of waiting for a push from mobile wallet provider 104.

A biller, such as the biller 106, may be an entity (e.g., corporation) that submits a recurring (or single) bills to their customers. The biller 106 may include customer accounts 126 and bills 128 for the customers associated with those accounts. The customer accounts 126 may also include a location to submit bills at predetermined durations such as every month or every other month. The location may be a website address and may include an application programming interface (API) format for submitting the bill. In an example, the website address is a webserver of mobile wallet provider 104. Exemplary billers are electric companies, waste management companies, cable television providers, credit card and debit card issuers, and phone service providers.

The bill pay subsystem 114 may be code executable on the processor 122 and may access a list of billers 202, payment settings 204, and notifications 206 stored on storage device 120 or secure element 121. The list of billers 202 may identify which billers the owner of mobile wallet 108 has set up for payment using one of payment elements 110.

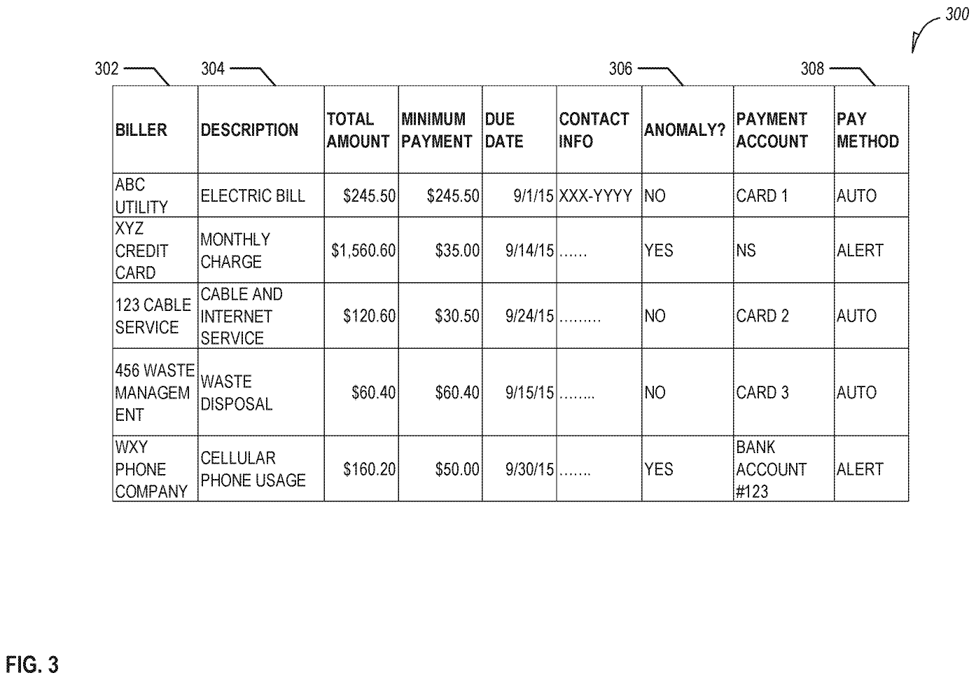

FIG. 3 is a table 300 of bills, according to various examples. The table 300 may be presented to a user on a display device of mobile device 102 upon activating a user interface element of the mobile wallet 108. The table 300 may be an overview of the bills the user has set up for bill pay using mobile wallet 108. The format and number of billers shown is exemplary in nature, and other formats may be used without departing from the scope of this disclosure.

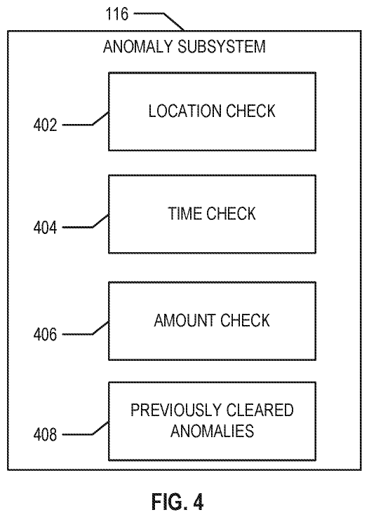

As illustrated, the table 300 includes a number of columns summarizing a particular bill. The biller column 302 shows a list of billers such as ABC Utility, XYZ Credit card, 123 Cable service, and so on. For each biller, the description column 304 may show a description of the bill, a total amount, a minimum payment, due date, and contact info. Furthermore, anomaly column 306 may indicate whether or not an anomaly was found for a bill, as discussed in more detail in FIG. 4. The table 300 may also indicate a payment account and an indication of how to pay in payment method column 308.

Some of the information in the table 300 may be extracted from bills received from a biller, some may be preferences entered by the user in mobile wallet 108, and some may be determined by automatic analysis of the bill. For example, the mobile wallet 108 may extract (e.g., using Optical Character Recognition (OCR) or from defined data fields in a bill) the biller's name, total amount, minimum payment, and due date. The user may enter in a description and enter in the payment account and information in payment method column 308. The payment account column may indicate a type of payment account the mobile wallet 108 should use in paying the bill. It may indicate a credit card name, bank account or other elements in the mobile wallet. An “NS” may indicate that user has not specified a payment account. The specified payment accounts and payment methods may be stored as payment settings 204.

In an example, more than one payment account from payment elements 110 may be specified for a bill. The user may specific a priority of payment accounts (e.g., using a drop-down menu to label first, second, third, choices.). The mobile wallet 108 may determine which account to pay with using the priority list and availability of funds in the accounts. Thus, the mobile wallet 108 may choose a second payment account if the mobile wallet indicates that the first chosen payment account in the priority list is overdrawn.

The payment method column 308 may be specified by the mobile wallet user. An “Auto” may mean to pay the bill without asking or alerting to the user on the payment due date. An “Alert” may mean that the mobile wallet 108 should alert the user with a pop-up window (or other type of alert) on the due date and the user may use the defined payment account, or take other action. The mobile wallet 108 may alert the user for bills with ‘NS’ on the due date and the user may select the payment method when he/she gets an alert on the payment date.

The anomaly column 306 may indicate if the bill includes any anomalous items in it. For instance, if a phone bill is twice as much compared to other months and the phone usage record in the phone does not indicate it (as explored in more detail below), the mobile wallet 108 may flag the cell in the table 300 as “Yes” in the anomaly column.

FIG. 4 is a block diagram of an anomaly subsystem, according to various examples. The anomaly subsystem 116 may review bills for anomalies when the bill is received (e.g., from biller 106). An anomaly may be one or more transactions (e.g., line items, total due, etc.) that deviate from regular behavior of a user or appears to not have originated from a user. For example, the anomaly subsystem 116 may utilize device-based data and non-device-based data to determine if a particular transaction is anomalous according to a set of rules/criteria.

The device-based data may be information specific to use of a device or function of devices. Exemplary device-based data are record of GPS location of the mobile device (e.g., location check 402), record of device usage (e.g., phone calls, chats, text), schedules in the calendar (e.g., time check 404), and usage record of the mobile wallet in the device. Examples of non-device-based data include user configuration on bill payment methods, bill payment history (e.g., amount check 406), general statistics, and specific user inputs (e.g., thresholds).

For illustration purposes, consider that a credit card bill has been received that includes a series of transactions (e.g., charges). Each transaction may have a variety of characteristics such as the time of a charge, the location of a charge, and an amount, The location check 402 may compare the location of the charge with the location of mobile device 102 at the time of the charge. For example, mobile device 102 may have a GPS sensor in sensors 118. A history of where the mobile device 102 has been may be stored by mobile wallet 108 or the operating system of the mobile device 102. The history may be queried at the time of the charge to determine if the mobile device 102 location and charge location match—if not, the bill may be flagged as having an anomaly.

In an example, the time check 404 may compare calendar records of a user to the time of a charge. Access to the calendar records may be given by a user to mobile wallet 108 when installing the wallet. Thus, if a calendar event indicates the user was flying at the time a charge was made, the charge may be flagged.

The amount check 406 may be used to look at an amount of a charge versus general spending habits for a particular biller. The user may set thresholds (e.g., via an input box of an interface mobile wallet 108) for how far above a charge may need to be to flag it. For example, the user may indicate any individual charge over $1000 should be flagged. In other instances, anomaly subsystem 116 may automatically set thresholds based on past spending (e.g., three standard deviations above the average charge for the past six months). Combinations of automatic and manual thresholds may be used for amount check 406.

Although the above description focuses on credit card charges, anomaly subsystem 116 may be used with other types of bills with different criteria. For example, a cell phone bill may be analyzed for anomalous data charges twice the average data usage for a month). A home internet service bill may be flagged as anomalous if data is being used when a calendar of a user indicates that user was not home, etc.

After performing one or more checks, a number of transactions may have been flagged as anomalous. However, some of these transactions may safely be ignored for a variety of reasons. For example, a transaction may be for an online store. Thus, even though location check 402 would likely indicate mobile device 102 was not in the same location as the charge, the anomalous flag may be removed—assuming the only flag was for location.

Furthermore, some anomalies may be removed based on previously cleared anomalies 408. For example, a user may click (e.g., tap) on a cell in the table 300 and the mobile wallet 108 may show a list of flagged transactions produced by the anomaly subsystem 116. The user may check if he/she used the credit card for making payment for the items in the anomaly list. If the user did, the user may unmark the flag to indicate that it is normal. If the user did not use the credit card to make payment for an item, the user may make a call to the credit card company or seller to resolve the issue. If the anomaly list is cleared, the mobile wallet 108 may remove the anomaly tag in the column and pay the bill accordingly.

The previously cleared anomalies 408 may be used to preemptively clear flagged transactions. For example, a user may clear a certain recurring transaction every month (e.g., a charge for $50 at a particular retailer). If the same transaction (e.g., similar or the same transaction characteristics) is cleared more than once, the transaction may be cleared before presenting it to the user in anomaly column 306. A user may examine the list of automatically cleared transactions for a biller and indicate a particular transaction should be flagged as anomalous regardless of being cleared in the past.

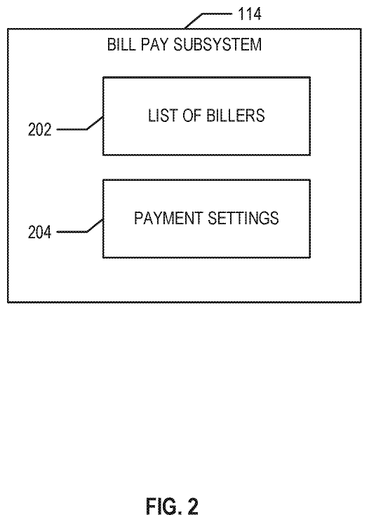

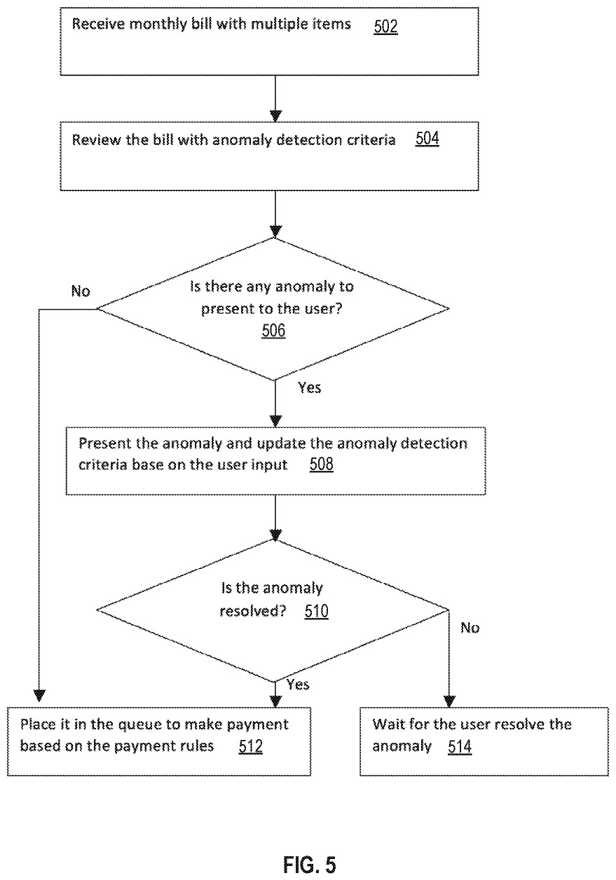

FIG. 5 is a flowchart of a method to detect anomalies, according to various examples. The mobile wallet 108 may receive a recurring (e.g., monthly) bill with multiple items (e.g., transactions) in operation 402. The mobile wallet 108 may review each item with anomaly detection criteria in operation 504 (e.g., location/time/amount checks). The mobile wallet 108 checks if there is any anomaly to present to the user in decision block 506 according to the criteria. If the answer is yes, the mobile wallet 108 flags the anomalies (e.g., updates a database entry for the items for the bill) and presents the anomalies to the user. Presenting may include updating a table such as that in FIG. 2 or another user interface element indicating anomalies are present for the bill.

The user may review the anomaly and the mobile wallet 108 may update the anomaly detection criteria in operation 508. Thus, as the user uses mobile wallet 108, the anomaly detection criteria may learn what matters to the user and flag less items. If there is no anomaly, or if the anomaly has been resolved (decision block 510), the bill payer places the bill in the payment queue to follow payment rules defined in payment settings 204 at operation 512. If there is an anomaly after the user reviews them, the mobile wallet 108 may hold the payment and wait for the user to resolve the anomaly at operation 514. Otherwise mobile wallet 108 may place the bill to the payment queue in operation 512. The user may come back after resolving any anomaly issues and then the mobile wallet 108 may remove the anomaly flag (e.g., update a database entry). The bill may then be placed in a payment queue according to payment settings 204.

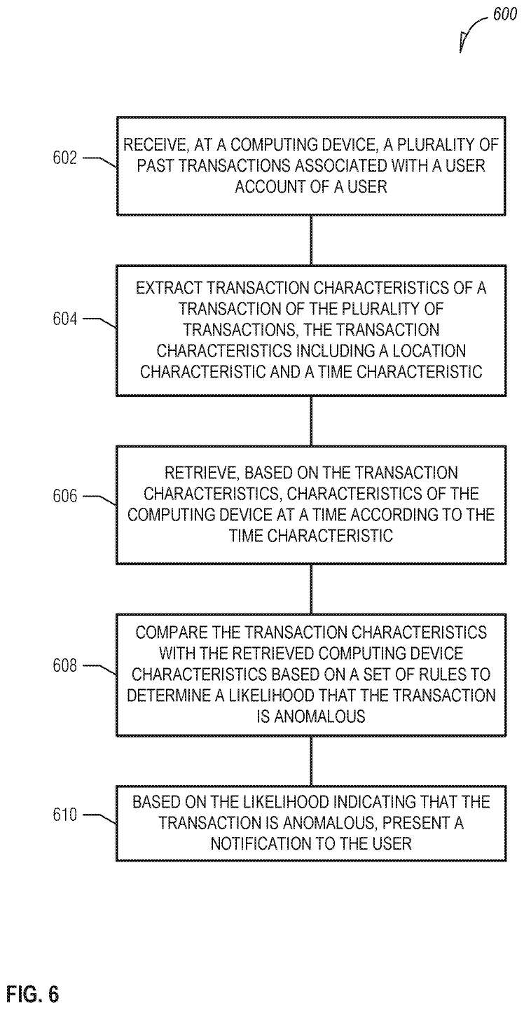

FIG. 6 is a flowchart of a method to detect anomalies, according to various examples. At operation 602, a plurality of past transactions are received at a computing device. The past transaction may be associated with a user account of a user. The user account may be for a biller of the user. The biller may transmit the plurality of transactions to the computing device directly, or through an intermediary, periodically.

At operation 604, in an example, transaction characteristics of a transaction of the plurality of transactions are extracted. The plurality of past transactions may be in a standardized format with defined fields for the characteristics. In other examples, the characteristics may be extracted using OCR techniques. Different billers may identify the characteristics in different locations. Accordingly, templates may be stored for the billers such that the characteristics may be efficiently OCRed. Different transactions may have different characteristics. For example, a charge transaction may include a location characteristic indicating where the charge was made and a time characteristic indicating where the charge occurred. A transaction from a phone bill may have caller characteristics.

At operation 606, in an example, characteristics of the computing device at a time according to the time characteristic are retrieved. Thus, if the transaction occurred at 5:00 PM on January 2, characteristics of the computing device corresponding to that date would be retrieved (e.g., from a database or log). The characteristics may include GPS data for location information, calendar data, phone usage data, accelerometer data, etc.

At operation 608, the transaction characteristics are compared with the retrieved computing device characteristics based on a set of rules to determine a likelihood that the transaction is anomalous. The likelihood may be a percentage or binary. The set of rules may define thresholds that, if passed, indicate a transaction is likely anomalous. The set of rules may be defined by a user or automatically based on statistical analysis of past transactions. The rules may be stored on a storage device of the computing device on a per biller basis or global basis.

In an example, location information of the computing device at the time according to the time characteristic is retrieved. The retrieved location information may be compared to the location characteristic to determine the likelihood a transaction is anomalous. A threshold radius may be set for flagging a transaction as anomalous (e.g., flag if the location information at the time was more than 1 mile away from the location characteristic).

In an example, calendar information of the computing device at the time according to the time characteristic is retrieved. The calendar information may be compared to the time characteristic to determine a likelihood a transaction was anomalous.

At operation 610, in an example, a notification is presented to the user based on the likelihood indicating that the transaction is anomalous. The notification may be presented in table form, e-mail, push notification, etc. The notification may identify that at least one of the past transactions is anomalous and give the user an opportunity to see each of the anomalous transactions.

A user interface element (e.g., checkbox) may also be presented to the user to clear the transaction as anomalous. If activated, the set of rules may be updated. For example, the rules may be updated to not flag the same type of transaction again.

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

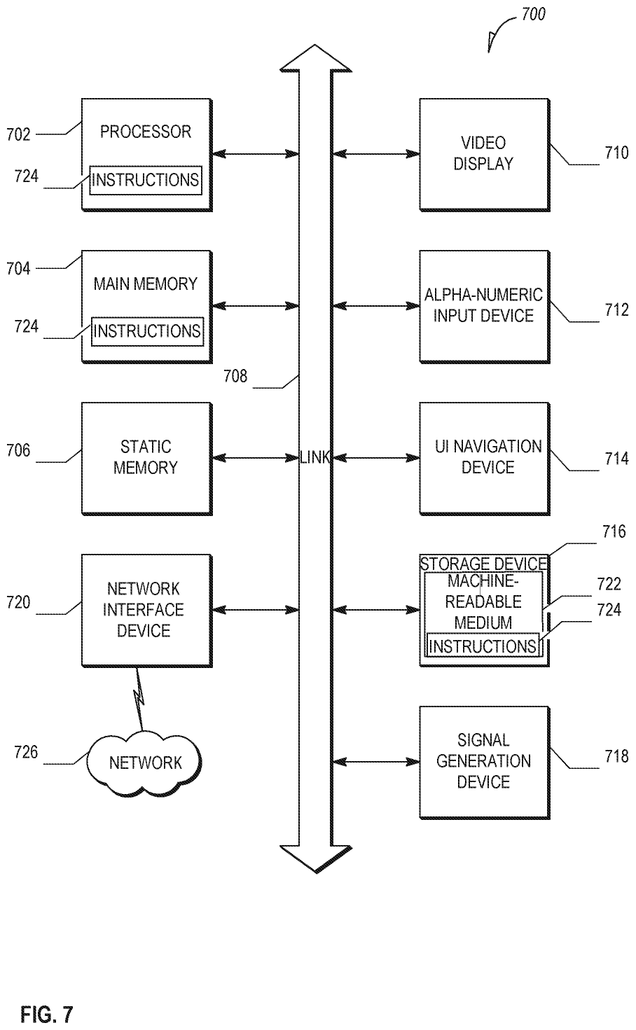

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 7G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
(A) determining past locations of a computing device using a global positioning system sensor of the computing device;
(B) determining times associated with the past locations of the computing device;
(C) storing the past locations and the times associated with the past locations of the computing device at a storage device of the computing device;
(D) extracting, by a mobile wallet executing at the computing device, a plurality of past transactions that have been completed over a period of time associated with a biller account, the biller account associated with a user account of a user, and wherein the biller account is configured to be paid using a mobile element of the mobile wallet stored on the computing device and the mobile wallet extracts the plurality of past transactions using optical character recognition;
(E) extracting using optical character recognition, by the mobile wallet, transaction characteristics of a first transaction of the plurality of past transactions, the transaction characteristics including a location characteristic and a time characteristic for the first transaction, the location characteristic indicating a past location where the first transaction was made and the time characteristic indicating when the first transaction was made;
(F) retrieving, by the mobile wallet, based on the transaction characteristics, corresponding characteristics of the computing device at a previous tune according to the time characteristic, wherein retrieving includes:
(G) retrieving the past location of the computing device at the previous time according to the time characteristic; and
(H) comparing, by the mobile wallet, the transaction characteristics with the retrieved computing device characteristics based on a set of rules to determine a likelihood that the first transaction is anomalous, wherein comparing includes:
(I) comparing the past location of the computing device with the past location where the first transaction was made;
(J) based on the likelihood indicating that the first transaction is anomalous, presenting, by the mobile wallet, a first notification to the user, wherein presenting the first notification to the user includes presenting a first user interface that includes:
identifying information that the first transaction is anomalous;
a user interface element to indicate the first transaction as anomalous;
(K) repeating operations (E)-(I) for a second transaction having characteristics similar to the first transaction and, based on the likelihood indicating that the second transaction is anomalous, presenting, by the mobile wallet, a second notification to the user, wherein presenting the second notification to the user includes presenting a second user interface that includes:
identifying information that the second transaction is anomalous;
a user interface element to indicate the second transaction as anomalous;
(L) receiving, from the user, an indication that the second transaction is anomalous at the user interface; and
(M) updating the set of rules based on indicating that the first transaction and the second transaction as anomalous and the similarity between the first transaction and the second transaction such that indicating the first transaction and the second transaction at the user interface as anomalous clears future transactions similar to the first transaction and the second transaction when the user indicates that the second transaction is anomalous at the user interface.

2-5. (canceled)

6. The method of claim 1, wherein retrieving, based on the transaction characteristics, characteristics of the computing device at the previous tune according to the time characteristic includes:
retrieving calendar information of the computing device at the previous time according to the time characteristic.

7. The method of claim 6, wherein comparing the transaction characteristics with the retrieved computing device characteristics based on the set of rules to determine the likelihood that the transaction is anomalous includes:
comparing the calendar information of the computing device to the time characteristic.

8. A non-transitory computer-readable medium, comprising instructions, which when executed by at least one processor, configure the at least one processor to perform operations comprising:
(A) determining past locations of a computing device using a global positioning system sensor of the computing device;
(B) determining times associated with the past locations of the computing device;
(C) storing the past locations and the times associated with the past locations of the computing device at a storage device of the computing device;
(D) extracting, by a mobile wallet executing at the computing device, a plurality of past transactions that have been completed over a period of time associated with a biller account, the biller account associated with a user account of a user, and wherein the biller account is configured to be paid using a mobile element of the mobile wallet stored on the computing device and the mobile wallet extracts the plurality of past transactions using optical character recognition;
(E) extracting using optical character recognition, by the mobile wallet, transaction characteristics of a first transaction of the plurality of past transactions, the transaction characteristics including a location characteristic and a time characteristic for the first transaction, the location characteristic indicating a past location where the first transaction was made and the time characteristic indicating when the first transaction was made;
(F) retrieving, by the mobile wallet, based on the transaction characteristics, corresponding characteristics of the computing device at a previous time according to the time characteristic, wherein retrieving includes:
(G) retrieving the past location of the computing device at the previous time according to the time characteristic; and
(H) comparing, by the mobile wallet, the transaction characteristics with the retrieved computing device characteristics based on a set of rules to determine a likelihood that the first transaction is anomalous, wherein comparing includes:
(I) comparing the past location of the computing device with the past location where the first transaction was made;
(J) based on the likelihood indicating that the first transaction is anomalous, presenting, by the mobile wallet, a first notification to the user, wherein presenting the first notification to the user includes presenting a first user interface that includes:
identifying information that the first transaction is anomalous;
a user interface element to indicate the first transaction as anomalous;
(K) repeating operations (E)-(I) for a second transaction having characteristics similar to the first transaction and, based on the likelihood indicating that the second transaction is anomalous, presenting, by the mobile wallet, a second notification to the user, wherein presenting the second notification to the user includes presenting a second user interface that includes:
identifying information that the second transaction is anomalous;
a user interface element to indicate the second transaction as anomalous;
(L) receiving, from the user, an indication that the second transaction is anomalous at the user interface; and
(M) updating the set of rules based on indicating the first transaction and the second transaction as anomalous and the similarity between the first transaction and the second transaction such that indicating the first transaction and the second transaction at the user interface as anomalous clears future transactions similar to the first transaction and the second transaction when the user indicates that the second transaction is anomalous at the user interface.

9-12. (canceled)

13. The computer-readable medium of claim 8, wherein retrieving, based on the transaction characteristics, characteristics of the computing device at the previous time according to the time characteristic includes:
retrieving calendar information of the computing device at the previous time according to the time characteristic.

14. The computer-readable medium of claim 13, wherein comparing the transaction characteristics with the retrieved computing device characteristics based on the set of rules to determine the likelihood that the transaction is anomalous includes:
comparing the calendar information of the computing device to the time characteristic.

15. A system comprising:
at least one processor; and
at least one storage device comprising instructions, which when executed by the at least one processor, configure to at least one processor to perform operations comprising:
(A) determining past locations of a computing device using a global positioning system sensor of the computing device;
(B) determining times associated with the past locations of the computing device;
(C) storing the past locations and the times associated with the past locations of the computing device at a storage device of the computing device;
(D) extracting, by a mobile wallet executing at the computing device, a plurality of past transactions that have been completed over a period of time associated with a biller account, the biller account associated with a user account of a user, and wherein the biller account is configured to be paid using a mobile element of the mobile wallet stored on the computing device and the mobile wallet extracts the plurality of past transactions using optical character recognition;
(E) extracting using optical character recognition, by the mobile wallet, transaction characteristics of a first transaction of the plurality of past transactions, the transaction characteristics including a location characteristic and a time characteristic for the first transaction, the location characteristic indicating a past location where the first transaction was made and the time characteristic indicating when the first transaction was made;
(F) retrieving, by the mobile wallet, based on the transaction characteristics, corresponding characteristics of the computing device at a previous time according to the time characteristic, wherein retrieving includes:
(G) retrieving a past location of the computing device at the previous time according to the time characteristic; and
(H) comparing, by the mobile wallet, the transaction characteristics with the retrieved computing device characteristics based on a set of rules to determine a likelihood that the first transaction is anomalous, wherein comparing includes:
(I) comparing the past location of the computing device with the past location where the first transaction was made;
(J) based on the likelihood indicating that the first transaction is anomalous, presenting, by the mobile wallet, a first notification to the user , wherein presenting the first notification to the user includes presenting a first user interface that includes:
identifying information that the first transaction is anomalous;
a user interface element to indicate the first transaction as anomalous;
(K) repeating operations (E)-(I) for a second transaction having characteristics similar to the first transaction and, based on the likelihood indicating that the second transaction is anomalous, presenting, by the mobile wallet, a second notification to the user, wherein presenting the second notification to the user includes presenting a second user interface that includes:
identifying information that the second transaction is anomalous;
a user interface element to indicate the second transaction as anomalous;
(L) receiving, from the user, an indication that the second transaction is anomalous at the user interface; and
(M) updating the set of rules based on indicating the first transaction and the second transaction as anomalous and the similarity between the first transaction and the second transaction such that indicating the first transaction and the second transaction at the user interface as anomalous clears future transactions similar to the first transaction and the second transaction when the user indicates that the second transaction is anomalous at the user interface.

16-19. (canceled)

20. The system of claim 15, wherein retrieving, based on the transaction characteristics, characteristics of the computing device at the previous time according to the time characteristic includes:
retrieving calendar information of the computing device at the previous time according to the time characteristic.
